(19) United States
(12) Patent Application Publication
(10) Pub. No.: US 2020/0026937 A1
(43) Pub. Date: Jan. 23, 2020

(54) INFORMATION PROVIDING DEVICE, VEHICLE, AND INFORMATION PROVIDING METHOD

(71) Applicant: HONDA MOTOR CO., LTD., Tokyo (JP)

(72) Inventors: Weifeng ZHANG, WAKO-SHI (JP); Hisumi ESAKI, WAKO-SHI (JP); Hiromi SATO, WAKO-SHI (JP); Yoshihiro MATSUGI, WAKO-SHI (JP); Yuki MATSUURA, WAKO-SHI (JP)

(21) Appl. No.: 16/515,382

(22) Filed: Jul. 18, 2019

(30) Foreign Application Priority Data
Jul. 19, 2018 (JP) 2018-135525

(51) Int. Cl. G06K 9/00

(52) U.S. Cl. CPC G06K 9/00838; G06F 3/16; G06K 9/00288

(57) ABSTRACT

An information providing device can appropriately select how to provide information from the outside depending on the number of occupants in a vehicle. The information providing device includes an individual recognition function that recognizes the occupant in the vehicle, and performs individual recognition in the vehicle before the information is provided to the vehicle occupant. The vehicle includes the information providing device. In an information providing method, the individual recognition in the vehicle is performed prior to providing the occupant in the vehicle with the information.

### CROSS-REFERENCE TO RELATED APPLICATION

This application is based upon and claims the benefit of priority from Japanese Patent Application No. 2018-135525 filed on Jul. 19, 2018, the contents of which are incorporated herein by reference.

### BACKGROUND OF THE INVENTION

### Field of the Invention

The present invention relates to an information providing device that includes an individual recognition function, a vehicle that includes the information providing device, and an information providing method.

### Description of the Related Art

An object of an agent device disclosed in Japanese Laid-Open Patent Publication No. 2001-056225 is to enable communication with a different agent in accordance with obtained information.

To achieve the object, the agent device disclosed in Japanese Laid-Open Patent Publication No. 2001-056225 employs the following configuration. In this Patent Literature, an area of expertise of each agent such as an agent who is good at a personal computer or an agent who well knows about restaurants and character of the agent such as gentle are decided together in advance, and necessary data (data such as information about the latest model of personal computer) is stored in an expertise area database for each agent. Then, communication information such as a weather forecast or traffic information that is transmitted several times a day from FM multiplex broadcast or a specific information provider is received, and the received communication information is classified into the areas of expertise and stored in the expertise area database. The areas of expertise corresponding to the communication information are decided in advance for each channel from which the communication information has been received, and the agent who is in charge of each channel is assigned to the channel. Then, if new communication information is received, the agent who is in charge of the area of expertise that is classified appears as necessary to perform guidance, explanation, or the like of the communication information.

### SUMMARY OF THE INVENTION

The main purpose of a vehicle described in Japanese Laid-Open Patent Publication No. 2001-056225 is to give advice or the like to a driver. To give various kinds of advice to the driver, a plurality of agents each corresponding to the area of expertise are set.

However, depending on the number of vehicle occupants in the vehicle (one, or two or more), disclosure of the information that is provided from the agent may be inconvenient. For example, in a case where a single vehicle occupant has received email or the like, if he is the only vehicle occupant in the vehicle, the agent can read aloud the content of the email. On the other hand, if he is one of the vehicle occupants in the vehicle, reading aloud of the content of the email may be inconvenient.

The present invention has been made in view of the above problem, and an object is to provide an information providing device that can appropriately select how to provide information from the outside depending on the number of vehicle occupants in the vehicle, a vehicle that includes the information providing device, and an information providing method.

A first aspect of the present invention is an information providing device that includes an individual recognition function that recognizes a vehicle occupant, wherein before information is provided to the vehicle occupant, individual recognition in a vehicle is performed.

A second aspect of the present invention is a vehicle that includes the information providing device.

A third aspect of the present invention is an information providing method for performing individual recognition in a vehicle prior to providing a vehicle occupant with information.

According to the first to third aspects of the present invention, how to provide the information from the outside can be selected appropriately depending on the number of vehicle occupants in the vehicle.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1A is an explanatory diagram that illustrates a vehicle in a state where there is a single occupant in the vehicle, and FIG. 1B is an explanatory diagram that illustrates the vehicle in a state where there are a plurality of occupants in the vehicle;

FIG. 2 is a block diagram that illustrates a configuration of an information providing device according to an embodiment;

FIG. 3 is an explanatory diagram that illustrates one example of a data format of information that is provided from the outside;

FIG. 4A is an explanatory diagram that schematically illustrates a scene where the vehicle enters a tunnel, and FIG. 4B is an explanatory diagram that schematically illustrates a scene where the vehicle exits the tunnel;

FIG. 5 is a flowchart (No. 1) of process operation of the information providing device according to the present embodiment; and

FIG. 6 is the flowchart (No. 2) of the process operation of the information providing device according to the present embodiment.

### DESCRIPTION OF THE PREFERRED EMBODIMENTS

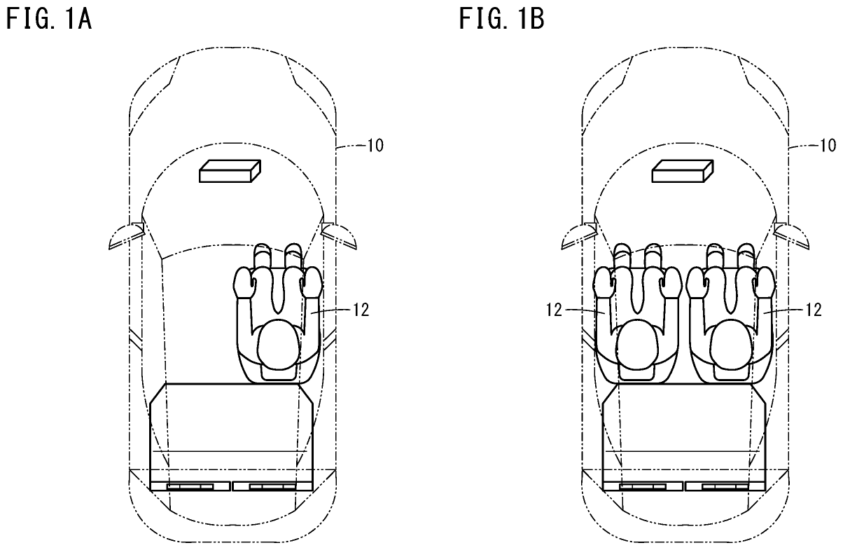

An embodiment of an information providing device, a vehicle, and an information providing method according to the present invention is hereinafter described with reference to FIG. 1A to FIG. 6.

As illustrated in FIG. 1A and FIG. 1B, a vehicle 10 according to the present embodiment includes an information providing device 14 including an individual recognition function that recognizes a vehicle occupant 12.

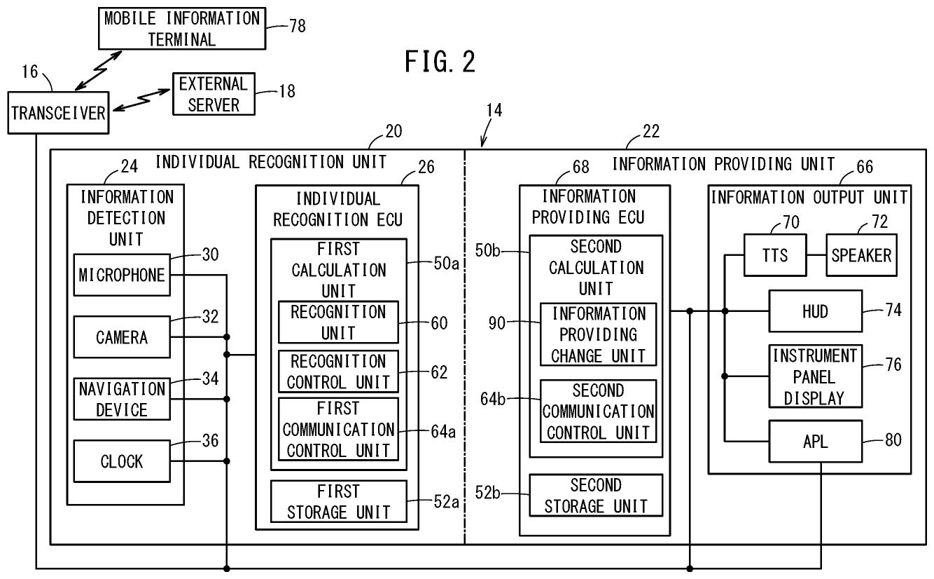

As illustrated in FIG. 2, the information providing device 14 provides the vehicle occupant 12 with information from the outside that is received by a transceiver 16 provided to the vehicle 10, for example, information from an external server 18 (for example, a server installed in a server room of a company or service provider that provides an individual recognition service and a personal information providing service).

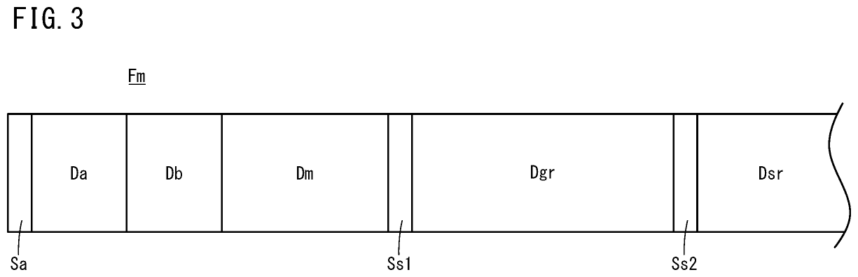

As illustrated in FIG. 3, for example, a data format Fm of the information that is provided from the external server 18 includes, an email start signal Sa, transmission source data Da, destination data Db, email data Dm (content), a first recommendation start signal Ss1, general-purpose recommendation data Dgr (content), a second recommendation start signal Ss2, and particular recommendation data Dsr (content) based on personal information.

The information providing device 14 includes an individual recognition unit 20 and an information providing unit 22. The individual recognition unit 20 includes an information detection unit 24 and an individual recognition ECU 26. The information detection unit 24 includes, for example, a microphone 30, a camera 32, a navigation device 34, a clock 36, and the like.

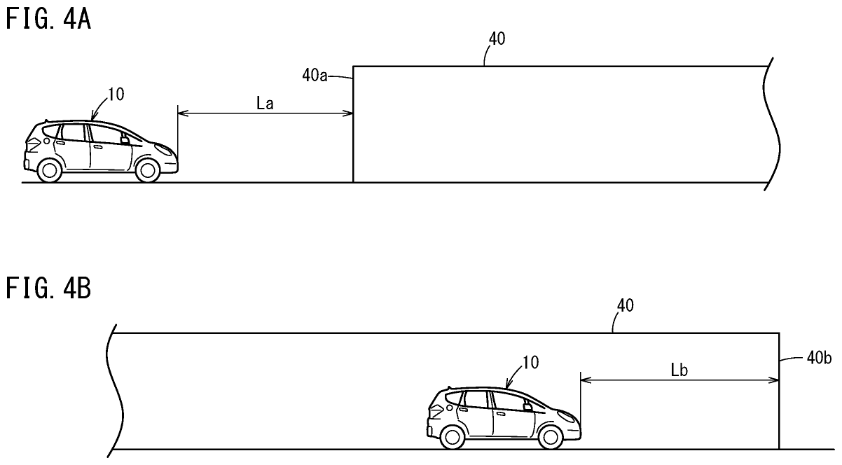

The camera 32 photographs, for example, a face of the vehicle occupant 12, and outputs this image information to the individual recognition ECU 26. As illustrated in FIG. 4A, for example, the navigation device 34 provides a distance La from the current position of the vehicle 10 to an entrance 40a of a tunnel 40. Moreover, as illustrated in FIG. 4B, for example, the navigation device 34 provides a distance Lb from the current position of the vehicle 10 to an exit 40b of the tunnel 40. For example, the clock 36 is used for measuring predetermined elapsed time from when the vehicle 10 enters the tunnel 40, and predetermined elapsed time from when the vehicle 10 exits the tunnel 40. Note that the information detection unit 24 may further include another device.

The individual recognition ECU 26 is an electronic control unit (ECU) that includes a first calculation unit 50a, a first storage unit 52a, and an input/output interface that is not shown. The first calculation unit 50a includes a processor including a CPU and the like and achieves various functions when the processor executes programs stored in the first storage unit 52a. In the present embodiment, the first calculation unit 50a functions as a recognition unit 60, a recognition control unit 62, and a first communication control unit 64a. The first storage unit 52a includes a storage device such as a ROM and a RAM.

The recognition unit 60 recognizes the existence of the vehicle occupant 12, and an owner of the vehicle 10 on the basis of the acquired information. For example, if the camera 32 acquires the image information, the recognition unit 60 performs a well-known image recognition process using the image information, and recognizes the existence of persons, that is, the number of persons and a position where each person is seated.

In addition, the recognition unit 60 compares the acquired image information with at least image information about the face of the owner included in identification information in the first storage unit 52a, and recognizes at least the owner and the position where the owner is seated.

Moreover, if voice information is acquired, the recognition unit 60 recognizes that a person is seated on a seat corresponding to the microphone 30 that has collected the voice. Furthermore, the recognition unit 60 compares the voice information with voiceprint information included in the identification information in the first storage unit 52a, and recognizes the owner.

Information recognized by the recognition unit 60 (recognition information) is stored in the first storage unit 52a. In addition, the recognition information is transmitted to the information providing unit 22 through the first communication control unit 64a.

Prior to providing the vehicle occupant 12 with the information, the recognition control unit 62 starts up the recognition unit 60 and causes the recognition unit 60 to recognize an individual in the vehicle 10. When the vehicle 10 enters the tunnel 40 (see FIG. 4A), the recognition control unit 62 controls the recognition unit 60 so that the individual recognition is not performed on the basis of the image information. Similarly, when the vehicle 10 exits the tunnel 40 (see FIG. 4B), the recognition control unit 62 controls the recognition unit 60 so that the individual recognition is not performed on the basis of the image information. At this time, the individual recognition based on the voice information may be operated as usual.

The first communication control unit 64a downloads provided information from the external server 18 that is received through the transceiver 16, for example, and stores the provided information in the first storage unit 52a.

On the other hand, the information providing unit 22 includes an information output unit 66 and an information providing ECU 68. The information output unit 66 includes a TTS 70 (Text-To-Speech), a speaker 72, an HUD 74 (Head-Up-Display), an instrument panel display 76 (a display whose screen can be confirmed by the driver only) provided to an instrument panel ahead of a driver's seat, for example, and an application (APL) 80 that vibrates a mobile information terminal 78 of at least the owner, for example.

The TTS 70 converts input text data into speech and outputs the speech. For example, the TTS 70 outputs the content of an email or recommendation information as voice sound. The speaker 72 amplifies the sound of the voice that is input from the TTS 70 and outputs the voice sound. The HUD 74 and the instrument panel display 76 display simplified information that is output from the information providing ECU 68, for example, a character, a mark, or a symbol expressing that the information has been provided from the external server 18. If the vehicle 10 is stopped, the HUD 74 and the instrument panel display 76 display, for example, the entire content of the email or the recommendation information that is provided.

The information providing ECU 68 is an electronic control unit (ECU) that includes a second calculation unit 50b, a second storage unit 52b, and an input/output interface that is not shown. The second calculation unit 50b includes a processor including a CPU and the like and achieves various functions when the processor executes programs stored in the second storage unit 52b.

In the present embodiment, the second calculation unit 50b functions as an information providing change unit 90 and a second communication control unit 64b. The second storage unit 52b includes a storage device such as a ROM and a RAM. Note that the recognition information that is transmitted from the individual recognition ECU 26 is stored in the second storage unit 52b through the second communication control unit 64b.

The information providing change unit 90 changes the content of the information that is provided from the outside depending on the number of the vehicle occupants 12. As illustrated in FIG. 1A, for example, if there is a single vehicle occupant 12, that is, only the owner, all of the content of the provided information is read aloud through the TTS 70 and the speaker 72, or is displayed in the HUD 74 or the instrument panel display 76. If the provided information includes the particular recommendation data Dsr based on the personal information, this particular recommendation data Dsr is read aloud or all of this particular recommendation data Dsr is displayed.

As illustrated in FIG. 1B, if a plurality of the vehicle occupants 12 are present, the information providing change unit 90 forbids reading aloud of the information provided from the outside, and the displaying of the entire information. Moreover, if the provided information includes the particular recommendation data Dsr, the information providing change unit 90 forbids the reading aloud of the particular recommendation data Dsr and the displaying of the entire particular recommendation data Dsr, and instead, the general-purpose recommendation data Dgr for everyone, for example, certain news items are read aloud.

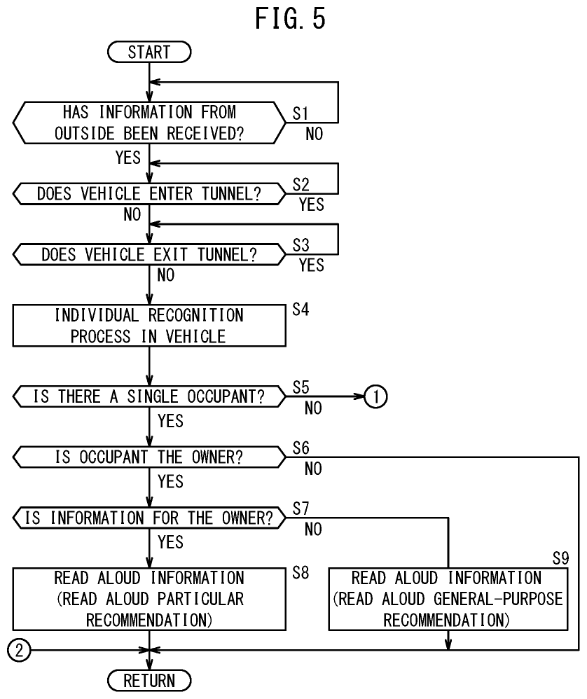

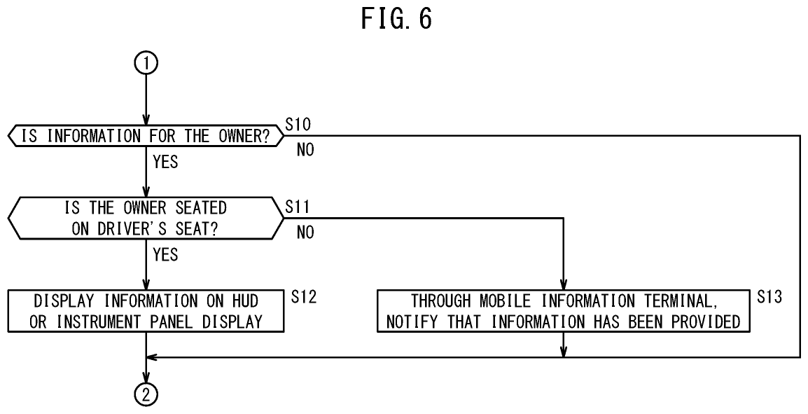

Next, a process operation of the information providing device 14 according to the present embodiment is described with reference to flowcharts in FIG. 5 and FIG. 6.

First, in step S1 in FIG. 5, the recognition control unit 62 determines whether the provided information from the external server 18 is newly received. This determination is performed depending on whether the information that is newly provided from the external server 18 is stored in the first storage unit 52a by the first communication control unit 64a, for example.

If the provided information is newly received (step S1: YES), the process advances to the next step S2 and the recognition control unit 62 determines whether the vehicle 10 is in a stage of entering the tunnel 40. This determination is performed depending on whether conditions “a” to be described below are satisfied.

### (Conditions a: see FIG. 4A)

a-1: The vehicle 10 is in a situation where the vehicle 10 is heading for the entrance 40a of the tunnel 40, that is, a situation where the distance La from the current position of the vehicle 10 to the entrance 40a of the tunnel 40 is decreasing as time elapses.

a-2: The distance La from the current position of the vehicle 10 to the entrance 40a of the tunnel 40 is less than or equal to a predetermined distance (for example, any distance selected from 5 to 30 m).

If the above conditions “a” are satisfied, it is determined that the vehicle 10 is in the stage of entering the tunnel 40 and the process in step S2 is repeated.

In step S2, if it is determined that the vehicle 10 is not in the stage of entering the tunnel 40, the process advances to step S3 and the recognition control unit 62 determines whether the vehicle 10 is in a stage of exiting the tunnel 40. This determination is performed depending on whether conditions “b” to be described blow are satisfied.

### (Conditions b: see FIG. 4B)

b-1: The vehicle 10 is in a situation where the vehicle 10 is heading for the exit 40b of the tunnel 40, that is, a situation where the distance Lb from the current position of the vehicle 10 to the exit 40b of the tunnel 40 is decreasing as time elapses.

b-2: The distance Lb from the current position of the vehicle 10 to the exit 40b of the tunnel 40 is less than or equal to a predetermined distance (for example, any distance selected from 5 to 30 m).

If the above conditions b are satisfied, it is determined that the vehicle 10 is in the stage of exiting the tunnel 40 and the process in step S3 is repeated.

In step S3 described above, if it is determined that the vehicle 10 is not in the stage of exiting the tunnel 40, the process advances to the next step S4 and the recognition control unit 62 performs an individual recognition process for the vehicle occupant 12.

That is to say, the camera 32 photographs, for example, the face of the occupant 12 in the vehicle 10, and this image information is supplied to the individual recognition ECU 26. As described above, the recognition unit 60 of the individual recognition ECU 26 recognizes, on the basis of the acquired information, the existence of the vehicle occupant 12 and the owner of the vehicle 10, and stores the recognition information in the first storage unit 52a. This recognition information is transmitted to the information providing ECU 68 through the first communication control unit 64a. The second communication control unit 64b of the information providing ECU 68 stores the recognition information from the individual recognition ECU 26 in the second storage unit 52b.

Next, in step S5, the information providing change unit 90 determines whether the number of the occupant 12 in the vehicle 10 is one, on the basis of the recognition information stored in the second storage unit 52b.

If there is a single vehicle occupant 12, the process advances to the next step S6 and the information providing change unit 90 determines whether the recognized vehicle occupant 12 is the owner on the basis of the recognition information. If the vehicle occupant 12 is the owner, the process advances to the next step S7 and it is determined whether the information provided from the external server 18 is for the owner. This determination is performed depending on whether the destination data Db of the data format Fm (see FIG. 3) of the information provided from the external server 18 is the data that expresses the owner.

If the information is for the owner, the process advances to the next step S8 and the information providing change unit 90 outputs the received data (for example, email data) to the speaker 72 through the TTS 70, for example. Thus, the content of the received data is read aloud as a voice sound. If the received data includes the particular recommendation data Dsr based on the personal information, the particular recommendation data Dsr is also read aloud.

In step S7 described above, if it is determined that the information is not for the owner, the process advances to step S9. Then, if the received data includes the general-purpose recommendation data Dgr (for example, news or weather forecast), the information providing change unit 90 outputs the general-purpose recommendation data Dgr to the speaker 72 through the TTS 70, for example. Thus, the general-purpose recommendation data Dgr is read aloud as a voice sound.

On the other hand, in step S5 described above, if it is determined that a plurality of the vehicle occupants 12 are present in the vehicle 10, the process advances to step S10 in FIG. 6 and the information providing change unit 90 determines whether the information provided from the external server 18 is for the owner. If the information is for the owner, the process advances to the next step S11 and the information providing change unit 90 determines whether the owner is seated on the driver's seat on the basis of the recognition information that is stored in the second storage unit 52b.

If the owner is seated on the driver's seat, the process advances to the next step S12 and the information providing change unit 90 displays the received data (for example, email data) on the instrument panel display 76 or the HUD 74. Thus, the driver can check the received data while another vehicle occupant 12 hardly notices the received data. At this time, a signal (incoming signal) may be output through the application 80 in order to vibrate the owner's mobile information terminal 78. The incoming signal is output to the driver's mobile information terminal 78 through the second communication control unit 64b and the transceiver 16. Thus, it is possible to prompt the owner to check the received data.

In step S11 described above, if it is determined that the owner is not seated on the driver's seat, the process advances to the next step S13 and the information providing change unit 90 outputs the incoming signal to the owner's mobile information terminal 78 through the application 80. Thus, the owner can notice that the data for the owner has been received.

The process of and after step S1 described above is repeated after a predetermined time has elapsed in the following cases: after the process in step S8, the process in step S9, the process in step S12, or the process in step S13 ends; or if it is determined that the vehicle occupant 12 is not the owner in step S6 as described above; or if it is determined that the information is not for the owner in step S10 as described above. [Technical Concept Obtained from Embodiment] In the present embodiment, the information providing device 14 includes the individual recognition function that recognizes the vehicle occupant 12, wherein before the information is provided to the vehicle occupant 12, the individual recognition in the vehicle 10 is performed.

Depending on the state of the occupant 12 in the vehicle 10, for example, whether there is a single vehicle occupant 12 or there are a plurality of vehicle occupants 12, it may be necessary to change how to provide the information. For example, if there is a single vehicle occupant 12, the information (email or the like) from the outside may be read aloud. However, if there are a plurality of vehicle occupants 12, the reading aloud of the email or the like may be inconvenient. In the present embodiment, before the information is provided to the vehicle occupant 12, the individual recognition in the vehicle 10 is performed. Thus, how to provide the information can be selected appropriately depending on the number of vehicle occupants 12.

In the present embodiment, the content of the provided information is changed depending on the number of the vehicle occupants 12. For example, if there is a single vehicle occupant 12, the entire information that is provided from the outside is read aloud, displayed, or the like. If there are a plurality of vehicle occupants 12, for example, the vibration or the display of the mark can be performed for expressing that the information has been provided from the outside.

In the present embodiment, if the plurality of vehicle occupants 12 are present, the reading aloud of the provided information is forbidden. Thus, it is helpful in the case where the reading aloud of the provided information (for example, content of email) is inconvenient.

In the present embodiment, if the provided information includes the recommendation based on the personal information and if the plurality of vehicle occupants 12 are present, the providing of the recommendation is forbidden. The recommendation based on the personal information is useful for the person who is interested in the recommendation. However, the recommendation may be useless or may be nothing but a noise for the person who is not interested in the recommendation. Therefore, if the plurality of vehicle occupants 12 are present, the providing of the recommendation is forbidden. Thus, for example, the vehicle occupants 12 do not feel uncomfortable and can enjoy driving.

In the present embodiment, if the plurality of vehicle occupants 12 are present, the information is provided to the driver only. The personal information of the driver (owner of the vehicle 10), for example, the face image of the owner that is used in the individual recognition may be registered while being associated with the information of the vehicle 10 or the like. Even if the plurality of vehicle occupants 12 are present, the email for the driver (including information expressing that email has been received) or the recommendation information is provided to the driver only.

Thus, the effect of providing only the driver with the information can be obtained.

In the present embodiment, the information is provided to the driver through the machine for providing only the driver with the information.

The machine for providing only the driver with the information is, for example, the instrument panel display 76 in the driver's seat, the HUD 74 for the driver, the mobile information terminal 78 of the driver, or the like. By providing the information through these machines, the driver can notice that the information has been provided while another vehicle occupant 12 hardly notices the information.

In the present embodiment, when the vehicle 10 exits the tunnel 40, the individual recognition based on the image information is not performed.

When the vehicle 10 exits the tunnel 40, the illumination environment is largely changed. Thus, there is a great concern about wrong recognition of the driver (owner). For example, another vehicle occupant 12 may be regarded as the owner by mistake, or the owner may be regarded as another vehicle occupant 12 by mistake. In these cases, for example, there is a concern that the information that should be sent to the owner may be sent to another vehicle occupant 12. Thus, it is preferable not to perform the individual recognition based on the image information. However, the individual recognition based on the voice information may be performed.

In the present embodiment, when the vehicle 10 enters the tunnel 40, the individual recognition based on the image information is not performed. When the vehicle 10 enters the tunnel 40, the illumination environment is largely changed. Thus, there is a great concern about the wrong recognition of the driver (owner). Also in this case, for example, there is a concern that the information that should be sent to the owner may be sent to another vehicle occupant 12. Thus, it is preferable not to perform the individual recognition based on the image information. However, the individual recognition based on the voice information may be performed.

The vehicle 10 according to the present embodiment includes the above information providing device 14. That is to say, before the information is provided to the vehicle occupant 12, the vehicle 10 performs the individual recognition in the vehicle 10. Thus, how to provide the information can be selected appropriately depending on the number of vehicle occupants 12.

In the information providing method according to the present embodiment, the individual recognition in the vehicle 10 is performed prior to providing the vehicle occupant 12 with information. Thus, how to provide the information can be selected appropriately depending on the number of vehicle occupants 12.

Note that the present invention is not limited to the embodiment described above, and can be changed freely in the range without departing from the concept of the present invention. Alternatively, various configurations can be freely combined as long as there is no technical contradiction.

What is claimed is:

1. An information providing device comprising an individual recognition function that recognizes a vehicle occupant, wherein before information is provided to the vehicle occupant, individual recognition in a vehicle is performed.

2. The information providing device according to claim 1, wherein content of the provided information is changed depending on number of the vehicle occupants.

3. The information providing device according to claim 2, wherein if the plurality of vehicle occupants are present, reading aloud of the provided information is forbidden.

4. The information providing device according to claim 2, wherein if the provided information includes recommendation based on personal information and if the plurality of vehicle occupants are present, providing of the recommendation is forbidden.

5. The information providing device according to claim 2, wherein if the plurality of vehicle occupants are present, the information is provided to a driver only.

6. The information providing device according to claim 5, wherein the information is provided to the driver through a machine for providing only the driver with the information.

7. The information providing device according to claim 1, wherein when the vehicle exits a tunnel, the individual recognition based on image information is not performed.

8. The information providing device according to claim 1, wherein when the vehicle enters a tunnel, the individual recognition based on image information is not performed.

9. A vehicle comprising an information providing device, the information providing device including an individual recognition function that recognizes a vehicle occupant, wherein before information is provided to the vehicle occupant, individual recognition in the vehicle is performed.

10. An information providing method for performing individual recognition in a vehicle prior to providing a vehicle occupant with information.
